(19) United States
(12) Patent Application Publication
(10) Pub. No.: US 2008/0169996 A1
(43) Pub. Date: Jul. 17, 2008

(54) WATERPROOF HOUSING

(75) Inventor: Sheng-Hsiung YANG, Hukou Township (TW)

Correspondence Address: WORKMAN NYDEGGER, 60 EAST SOUTH TEMPLE, 1000 EAGLE GATE TOWER, SALT LAKE CITY, UT, 84111, US

(73) Assignee: SMARTANT TELECOM CO., LTD., Jhudong Township (TW)

(21) Appl. No.: 12/014,642

(22) Filed: Jan. 15, 2008

(30) Foreign Application Priority Data
Jan. 17, 2007 (TW) 096200910

(51) Int. Cl. H01Q 1/42

(52) U.S. Cl. 343/872

(57) ABSTRACT

A waterproof housing is used for accommodating electronic components of an antenna device. The waterproof housing includes a casing and a base body. The casing has a plurality of combination holes disposed on a sidewall thereof, and the electronic components are disposed on the base body. The base body has a plurality of combination members corresponding to the combination holes. The electronic components are accommodated inside the casing by snapping the combination members and the combination holes. The positions of the electronic components are higher than those of the combination holes, when rain water comes into the casing through the combination holes, the rain water will flow down into the base body, and thus the electronic components are prevented from being wet and damaged by the rain water.

### CROSS-REFERENCE TO RELATED APPLICATIONS

This non-provisional application claims priority under 35 U.S.C. § 119(a) on Patent Application No(s). 096200910 filed in Taiwan, R.O.C. on Jan. 17, 2007, the entire contents of which are hereby incorporated by reference.

### BACKGROUND OF THE INVENTION

1. Field of Invention

The present invention relates to a waterproof housing. More particularly, the present invention relates to a waterproof housing of electronic components, which is applicable to an outdoor antenna to prevent the antenna from being wet by external liquid.

2. Related Art

Currently, various antennae are available, which are roughly classified into indoor antennae and outdoor antennae. Taking an outdoor antenna as an example, it must be considered that when the antenna structure is installed outdoors for use, electronic components inside a casing must be protected from being invaded by rain water or other liquid, so as to avoid the damage of the electronic components disposed in the casing. Therefore, for the outdoor antenna, the waterproof function is one of the indispensable and important conditions.

A common conventional outdoor antenna structure has a housing formed by combining an upper casing and a lower casing and locking with screws, such that an accommodation space capable of accommodating the electronic components inside the casings is formed. However, the rain water likely penetrates into the casings through a combination gap between the two casings, and resulting in the damage of the internal parts. Therefore, when assembling a conventional antenna structure, an O ring is generally installed between the upper casing and the lower casing additionally, and a waterproof adhesive is filled into gaps between the O ring and the casings fully to have a waterproof function, so as to protect the internal parts from water. Additionally, a plastic material can be perfused by injection molding, so as to fill the gaps between the external casing and the electronic components fully, such that the electronic components are wrapped in the external casing by the plastic material, thereby achieving the waterproof purpose of the outdoor antenna.

However, regardless the waterproof adhesive wrapping the joint of the housing or the plastic material filled in the casing and wrapping the electronic components, after a long term of using, the materials are likely to be cracked and fall off due to the deterioration, such that the rain water will penetrate into the housing through deteriorated regions and cause undesired influence on the electronic components, thereby reducing the efficacy and working life of the outdoor antenna structure.

Furthermore, in the conventional antenna waterproof structure, a large number of screws are required for locking during assembling and disassembling the antenna, and thus the assembling process is complicated and time-consuming. In addition, a large amount of waterproof adhesive or plastic material is required during the manufacturing process, such that the manufacturing cost is significantly increased, which does not meet the needs of economic benefits.

### SUMMARY OF THE INVENTION

In view of the above problems, the present invention provides a waterproof housing to solve the problem in the prior art that external liquid, such as rain water, likely penetrates into the inner space of an outdoor antenna and thus damaging electronic components of the antenna device.

The present invention provides a waterproof housing for accommodating an antenna structure having a plurality of electronic components. The waterproof housing includes a casing and a base body. The casing has an accommodation space therein, an opening corresponding to the accommodation space and opened a downward opening, and a plurality of combination holes disposed near to the opening. The base body is selectively disposed on the opening and has a fixing plate and a plurality of combination members corresponding to the combination holes. The fixing plate is used to hold the electronic components of the antenna, and the position of the fixing plate is higher than the positions of the combination members. The combination members further each have an elastic portion and a snapping portion extending from the elastic portion. When the base body is disposed on the opening, the snapping portions of the combination members are combined with the combination holes, and the positions of the electronic components accommodated in the casing are higher than those of the combination holes.

The advantage of the present invention lies in that, the positions of the electronic components accommodated in the casing are higher than those of the combination holes, when external liquid, such as rain water, penetrates into the casing through the combination holes, the rain water will flow down into the base body due to the gravity, such that the electronic components are prevented from being wet and resulting in short circuit, and even being damaged. The casing and the base body are joined by snapping the combination holes and the combination members and can be disassembled without any auxiliary tools, and thus the installation process is fast and simple.

### BRIEF DESCRIPTION OF THE DRAWINGS

The present invention will become more fully understood from the detailed description given herein below for illustration only, and thus are not limitative of the present invention, and wherein:

FIG. 1 is an exploded view of a first embodiment of the present invention;

FIG. 2A is a perspective view of the first embodiment of the present invention;

FIG. 2B is a perspective rear view of the first embodiment of the present invention;

FIG. 2C is a schematic plan view of the first embodiment of the present invention;

FIG. 3 is a perspective view of the present invention fixed on a rod;

FIG. 4A is an exploded view of a second embodiment of the present invention; and

FIG. 4B is an exploded view of the second embodiment of the present invention with a base body disposed on a casing.

### DETAILED DESCRIPTION OF THE INVENTION

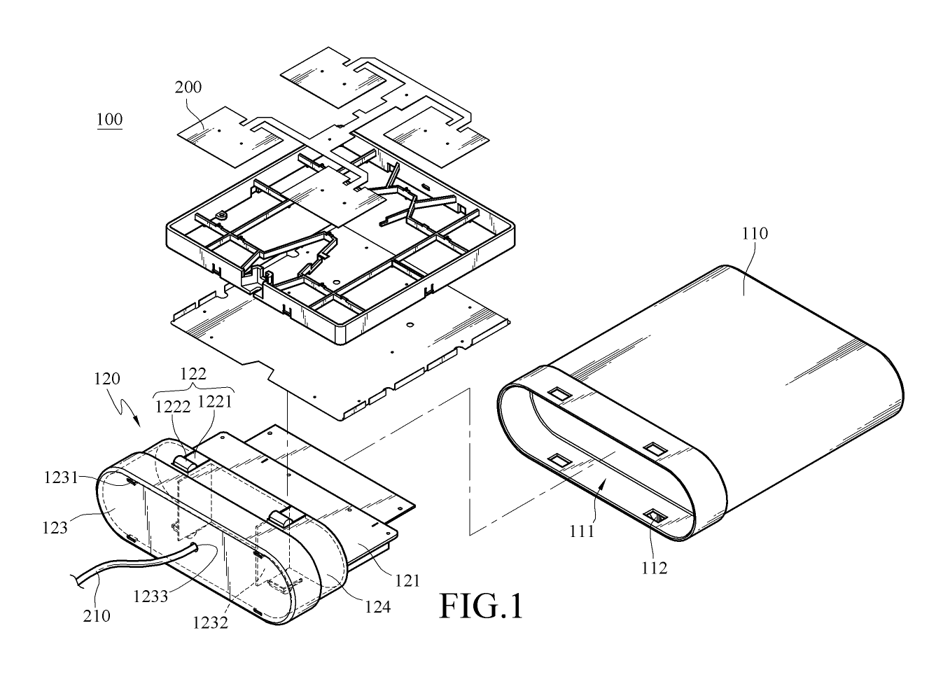

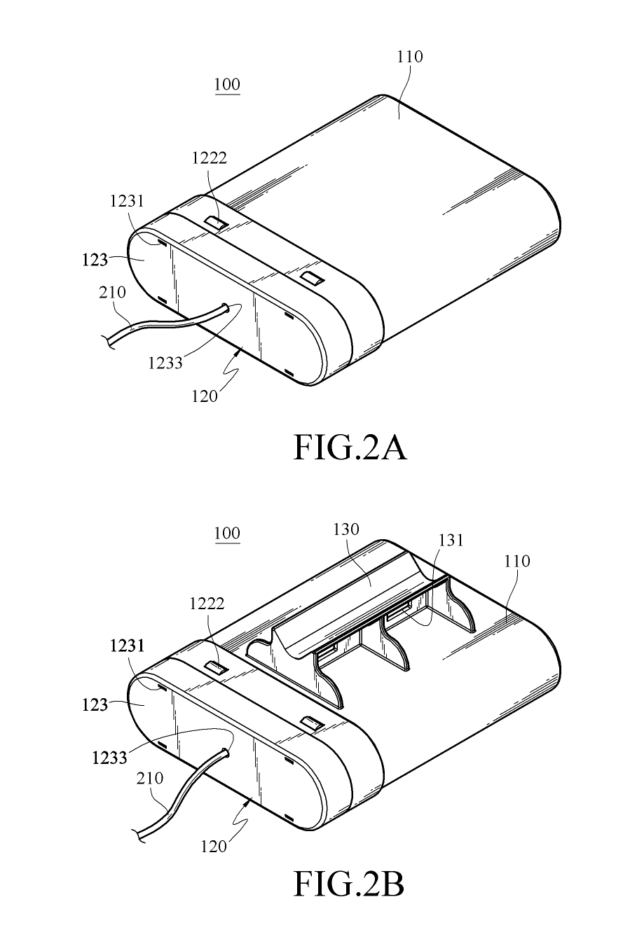

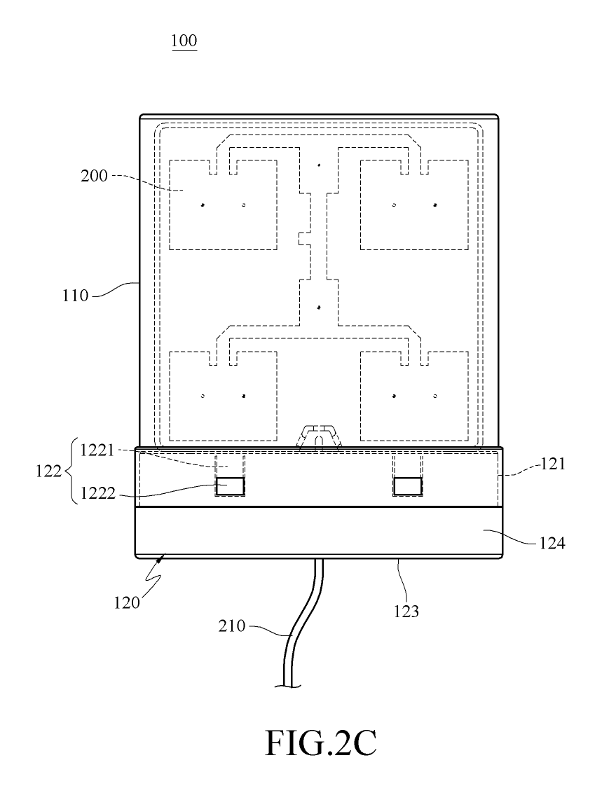

FIGS. 1 to 2C are schematic exploded views and schematic plan view of a first embodiment. As shown in the figures, a waterproof housing 100 of the present invention is used for disposing an antenna device. The antenna device has a plurality of electronic components 200 and a signal connection line 210. The waterproof housing 100 includes a casing 110 and a base body 120. The casing 110 has an accommodation space inside, an opening 111 opened downwards in the casing 110 and corresponding to the accommodation space, and a plurality of combination holes 112 disposed on a sidewall of the casing 110 near to the opening 111. The base body 120 has a seat 123 and a sidewall 124 standing vertically on the seat 123 and in the shape of a closed ring. The seat 123 has a fixing plate 121 for holding the electronic components 200. A plurality of combination members 122 are disposed on an outer side of the sidewall 124 and corresponding to the combination holes 112 of the casing 110. It is notable that, the position of the fixing plate 121 is higher than those of the combination members 122.

The combination members 122 further each have an elastic portion 1221 and a snapping portion 1222 extending from the elastic portion 1221. When the base body 120 is selectively disposed on the opening 111 of the casing 110, the snapping portion 1222 and the combination hole 112 of the casing 110 are snapped together, and the elastic portion 1221 provides an elastic force, such that the snapping portion 1222 is kept in a snapped state. At the same time, the positions of the electronic components 200 accommodated in the casing 110 are higher than those of the combination holes 112. The snapping portion 1222 and the combination holes 112 are closely combined due to the elastic force of the elastic portion 1221. When the rain water is splashed on the outer side of the waterproof housing 100, the snapping portions 1222 snapped in the combination holes 112 prevent the rain water from entering the casing 110. If the rain water flows into the casing 110 through the combination holes 112 accidentally, as the positions of the electronic components 200 are higher than those of the combination holes 112, the electronic components 200 will not be wet by the rain water to be damaged.

Please refer to FIGS. 1 to 2C, the base body 120 has a plurality of drain holes 1231 respectively disposed around the seat 123, for successfully discharging the rain water accidentally flow through the combination holes 112, thus preventing a liquid, such as rain water, from remaining or accumulating in the waterproof housing 100 to exert undesired influences, such as corrosion, on the electronic components 200. Furthermore, the seat 123 has two baffles 1232 erected thereon, which are joined with the sidewall 124 of the base body 120, so as to divide the seat 123 into three regions. The seat 123 at the middle region further has a through hole 1233 opened, for disposing a signal connection line 210 to the external of the base body 120 for electrical connection.

When the base body 120 is disposed on the opening 111 of the casing 110, the positions of the baffles 1232 are higher than those of the combination holes 112, such that no combination hole 112 exits at the position of the middle region of the through hole 1233 corresponding to the position of the casing 110. The rain water entering through the combination holes 112 accidentally will flow into the other two regions and then flow to the outside through the drain holes 1231, thus preventing the rain water from penetrating through the combination holes 112 to damage the signal connection line 210. If the rain water accidentally flows into the regions having the through hole 1233, the rain water will be discharged through the through hole 1233.

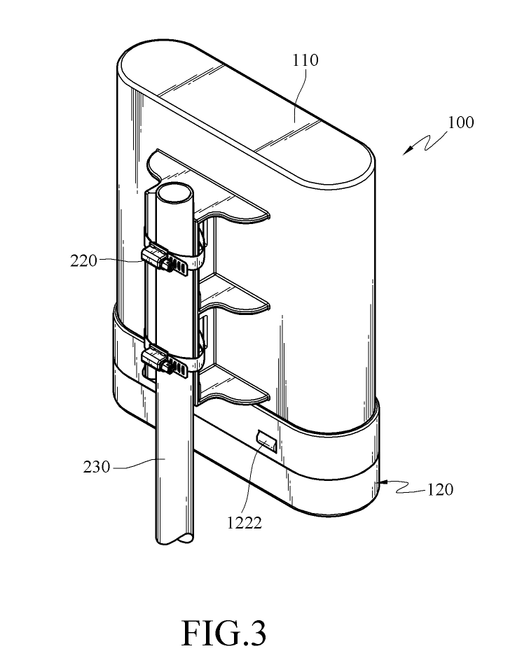

As shown in FIGS. 2B and 3, the casing 110 has a fixture 130 disposed at a side, and at least one via 131 penetrating the fixture 130 are opened thereon, for disposing a plurality of hose clamps 220. A side of the fixture 130 is of an arc-shaped structure, thus being capable of fitting a rod 230, such that the hose clamps 220 pass through the via 131 of the fixture 130, so as to fasten and fix the casing 110 on the rod 230.

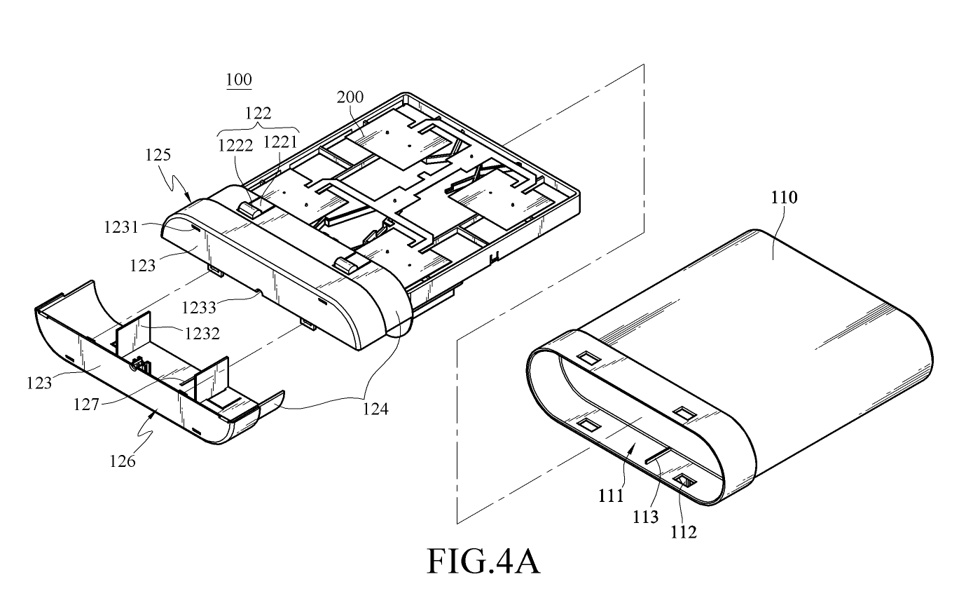

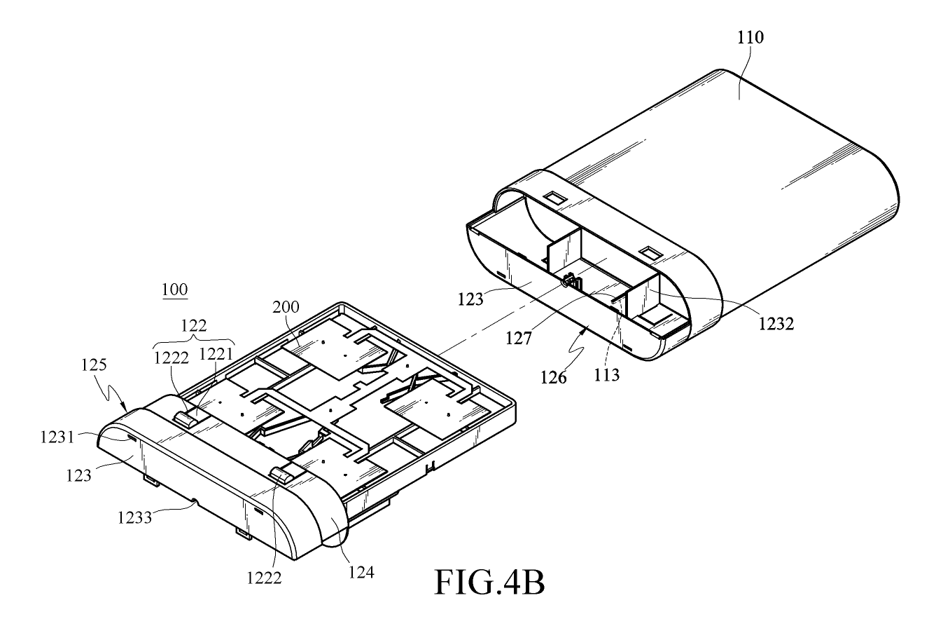

FIGS. 4A and 4B show exploded views of a second embodiment of the present invention. As shown in the figures, the base body 120 of the present invention further includes a first base 125 and a second base 126 symmetric to the first base 125. The electronic components 200 are disposed on the first base 125, and the sidewalls 124 of the first base 125 and the second base 126 have combination members 122 corresponding to the combination holes 112 respectively. A user can assemble or disassemble one of the bases 125, 126 at the opening 111 of the casing 110 individually. Such, if it is required to check the situation of the electronic components 200 inside, it is unnecessary to disassemble the entire base body 120, and it merely needs to disassemble the first base 125 to check the electronic components 200.

Referring to FIGS. 4A and 4B, the casing 110 has a rib 113 disposed at an inner sidewall near to the opening 111. The second base 126 has a guide groove 127 corresponding to the rib 113, for guiding the second base 126 to be disposed on the opening 111, thus facilitating the user to accurately dispose the two bases 125, 126 on the base body 10 rapidly.

The waterproof housing of the present invention is used for dispose an outdoor antenna device, and the positions of the antenna components disposed in the casing are higher than those of the combination holes of the casing, such that the rain water penetrated inside through the combination hole will flow downwards due to the gravity, and thus the electronic components will not be wet by the rain water to be damaged. The casing and the base body of the present invention are combined by snapping the combination members and the combination holes. The combination members not only have the function of water proofing, but also can be assembled or disassembled without using a screwdriver or any auxiliary tools, and thus the manufacturing cost is low, and the use convenience is significant improved.

What is claimed is:

1. A waterproof housing, applicable to an antenna comprising a plurality of electronic components and a signal connection line, comprising:
a casing, having an accommodation space inside, and provided with an opening corresponding to the accommodation space and opened downwards, and a plurality of combination holes disposed near to the opening; and
a base body, selectively disposed on the opening, and comprising a fixing plate and a plurality of combination members corresponding to the combination holes, wherein the fixing plate is used to hold the electronic components and the signal connection line, the position of the fixing plate is higher than those of the combination members, and each combination member further comprises a elastic portion and a snapping portion extending from the elastic portion, when the base body is disposed on the opening, the snapping portion and the combination hole are snapped together.

2. The waterproof housing as claimed in claim 1, wherein the casing comprises a fixture at a side, and at least one via is disposed on the fixture, for disposing at least one hose clamp, so as to fix the fixture on a rod.

3. The waterproof housing as claimed in claim 1, wherein the base body comprises a seat and a sidewall erected on the seat and in a shape of closed ring, wherein the seat comprises at least one drain hole, and the sidewall comprises a plurality of combination members.

4. The waterproof housing as claimed in claim 3, wherein the seat further comprises a baffle erected thereon and connected with the sidewall, so as to separate the base body into a plurality of regions, and the position of the baffle in the casing is higher than those of the combination holes.

5. The waterproof housing as claimed in claim 4, wherein the seat further comprises a through hole for disposing the signal connection line, and the through hole is disposed in one of the regions.

6. The waterproof housing as claimed in claim 1, wherein the base body further comprises a first base and a second base, the fixing plate is disposed on one of the bases, and the first base and the second base are respectively provided with at least one combination member corresponding to the combination hole, such that the first base and the second base are selectively disposed at the opening individually.

7. The waterproof housing as claimed in claim 6, wherein the casing comprises a rib disposed at an inner side near to the opening, and one of the bases comprises a guide groove corresponding to the rib, for guiding the base to be disposed on the opening.
